(19) United States
(12) Patent Application Publication
(10) Pub. No.: US 2009/0107607 A1
(43) Pub. Date: Apr. 30, 2009

(54) Tire with Anchor Comprising a Bielastic Reinforcing Element

(76) Inventor: Jean-Michel Huyghe, Clermont-Ferrand (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/302,274

(22) PCT Filed: May 14, 2007
(86) PCT No.: PCT/EP07/04257

§ 371 Date: Nov. 24, 2008

(30) Foreign Application Priority Data
May 22, 2006 (FR) 0604646

(51) Int. Cl. B60C 15/06

(52) U.S. Cl. 152/541; 152/539

(57) ABSTRACT

Tire comprising at least one carcass-type reinforcing structure (6) anchored on each side of the tire in a bead (4). The anchoring includes a turning up of said carcass-type reinforcing structure around a bead core (15) in such a way as to form a turned-up section (8) ending in a free end (13). The tire also includes at least one circumferential bielastic reinforcing element (10) made of a bielastic fabric, in which said fabric employed is a bielastic knitted fabric, that is to say a stitched fabric, the loops forming the stitches of which are able to move relative to each other in the knitting direction and in the direction perpendicular to the knitting. The at least one bielastic reinforcing element (10) is arranged so as to extend along the end region of the turned-up section of the carcass-type reinforcing structure.

The invention relates to a tire comprising at least one circumferential bielastic reinforcing element made of a bielastic fabric.

As is well known, tires are incessantly subjected to numerous mechanical stresses arising from various causes dependent on, in particular, the type of vehicle, the driver's driving style, the type of route followed, the general condition of the roads on which the vehicle is traveling, and so forth. Each of these parameters has an impact, direct or indirect, on the type and severity of mechanical stresses and strains imposed on the tire in the course of its use. Furthermore, the lower region of the tire is particularly affected by these phenomena because this region concentrates many of the stresses, particularly because of the presence of the hook of the rim, which, being in direct contact with the lower region of the tire, produces a stress concentration region.

The subject of the invention is consequently a tire comprising at least one carcass-type reinforcing structure extending circumferentially from the bead to said sidewall and anchored on each side of the tire in a bead, the base of which latter is designed to be mounted on a wheel rim seat, said anchoring comprising a turning up of said carcass-type reinforcing structure around a bead core in such a way as to form, along a radially inner portion of the bead core, a turning-up portion of the reinforcing structure from a point axially inside the bead core to a point axially outside the bead core, and then extending radially out from the base of said bead core in such a way as to form a turned-up section ending in a free end, each bead being continued radially outwardly by a sidewall, the sidewalls meeting, in the radially outward direction, a tread, said tire also comprising at least one circumferential bielastic reinforcing element made of a bielastic fabric, in which the fabric employed is a bielastic knitted fabric, that is a stitched fabric, the loops forming the stitches of which are capable of moving relative to each other in the knitting direction and in the direction perpendicular to the knitting, said at least one bielastic reinforcing element being arranged so as to extend (substantially parallel) along the end zone of the turned-up section of the carcass-type reinforcing structure (that is to say, at a shorter distance from the turned-up section of the reinforcing structure than from the axially inward portion of the reinforcing structure). By means of such an application of the bielastic reinforcing element, the mechanical properties of the tire, such as its durability and impact resistance, are improved. The bielastic reinforcing element creates an effect of energy absorption and diffusion which is beneficial to these properties.

The use of a bielastic reinforcing element improves the crack propagation resistance. The durability and service life of the products can thus be improved. This form of architecture is particularly advantageous in the case of tires for passenger cars, this type of tire being liable to be severely stressed in certain types of use, such as high-speed cornering and/or in certain types of hostile environment, when the lower region comes under severe stresses. The present invention reduces the harmful effects of such stresses.

According to an advantageous embodiment of the invention, at least one bielastic reinforcement is arranged axially outwardly relative to the turned-up section of the carcass-type reinforcing structure.

According to another advantageous embodiment of the invention, at least one bielastic reinforcement is arranged axially inwardly relative to the turned-up section of the carcass-type reinforcing structure. The reinforcement is preferably positioned closer to the turned-up section than to the axially inward portion of the carcass-type reinforcing structure.

According to yet another advantageous embodiment of the invention, the bielastic reinforcement comprises on the one hand a portion arranged axially inwardly relative to the turned-up section of the carcass-type reinforcing structure, and on the other hand a portion that is continued radially outwardly past the end of the turned-up section of the carcass-type reinforcing structure. Said portion that is continued radially outwardly past the end of the turned-up section of the carcass-type reinforcing structure is preferably continued axially outwardly relative to the turned-up section of the carcass-type reinforcing structure.

According to yet another advantageous embodiment of the invention, said bielastic reinforcing element comprises a first, substantially radial portion arranged axially outwardly relative to the turned-up section of the carcass-type reinforcing structure, a second, substantially radial portion arranged axially inwardly relative to the turned-up section of the carcass-type reinforcing structure, and a third, curvilinear portion connecting together the first two portions by passing radially outwardly relative to the end of the turned-up section of the carcass-type reinforcing structure, these various portions forming an inverted U-shaped hook enclosing at least one end of a turned-up section.

According to a first variant of this embodiment, the turned-up section of the carcass-type reinforcing structure is divided into at least two series of thread ends that are spaced out axially and are arranged such that they alternate circumferentially, and said hook individually encloses each series of ends; in a second variant of this embodiment, the turned-up section of the carcass-type reinforcing structure is divided into at least two series of thread ends that are spaced out axially and are arranged such that they alternate circumferentially, and said hook conjointly encloses the two series of ends.

According to another advantageous embodiment, the tire comprises two reinforcing structures, each comprising a turned-up portion, each being provided with an end, and said bielastic reinforcing element being engaged on at least one of these two ends. In various advantageous embodiments, the bielastic reinforcing element forms an inverted U-shaped hook enclosing either a single end, or both ends simultaneously.

According to still another advantageous embodiment, the tire comprises a circumferential strip provided with threadlike reinforcing elements and juxtaposed on at least one portion of an end, said bielastic reinforcing element being engaged on said strip. According to an advantageous embodiment, the bielastic reinforcing element forms an inverted U-shaped hook enclosing the end of said strip. According to a variant, the bielastic reinforcing element forms an inverted U-shaped hook that encloses both the end of said strip and the end of a turned-up section.

The bielastic fabric advantageously has at least one and preferably all of the following properties:
an elastic elongation ratio of at least 8%, and
a stitch size less than or equal to 150 stitches per decimeter, and preferably 200 stitches per decimeter.

Said fabric preferably comprises at least one material selected from polyamides, polyesters, rayon, cotton, wool, aramid, silk and flax.

The fabric advantageously comprises a certain proportion of elastic threads.

Also advantageously, the fabric or knitted fabric has a thickness between 0.2 mm and 2 mm, and preferably between 0.4 and 1.2 mm.

The fabric or knitted fabric has a mass per unit area of preferably generally between 70 and 700 g/m², and preferably between 140 and 410 g/m².

According to another advantageous embodiment, the bielastic knitted fabric is composed of at least one polymer selected from heatsetting polymers and thermoplastic polymers.

The fabric employed is advantageously a bielastic knitted fabric, that is a stitched fabric, the loops forming the stitches of which are capable of moving relative to each other in the knitting direction and in the direction perpendicular to knitting. “Bielastic” here means that the material in question possesses properties such as to render it elastic in at least two substantially perpendicular directions, and preferably in all directions.

The use of elastomeric fibers for making this fabric or knitted fabric is not therefore indispensable. A small proportion of such fibers may optionally be used to facilitate the implementation and ease the elastic return.

If however mechanical decoupling is all that is desired, the use of an elastomeric matrix may provide a way of amplifying the decoupling ability.

The expression “bielastic fabrics” also covers structures that can deform elastically reversibly but that are not necessarily produced by knitting. They may in particular be structures obtained by crocheting, or looped or needle-punched assemblies.

The interlacing of the loops forms a network which is deformable elastically in two substantially perpendicular directions. In the advantageous case of using a bielastic knitted fabric, the deformation capacity of this bielastic knitted fabric according to the invention is particularly due to the knitted structure, the fibers of the knitted fabric sliding over each other in the stitched network. In general terms, the elastic elongation ratio of the bielastic knitted fabric according to the invention is at least 10% in at least one of the two directions of elongation. It is advantageously 50% or more, or even more especially 100% or more. It is to be understood that these properties refer to the knitted fabric before its incorporation into the tire according to the invention.

The direction in which the bielastic knitted fabric is laid on the regions to be protected is advantageously such that that direction of the knitted fabric which has the highest elongation ratio is parallel to the direction of the highest stress acting on said region.

Other features and advantages of the invention will become apparent on reading an example of an embodiment of a tire according to the invention, with reference to the appended figures, in which:

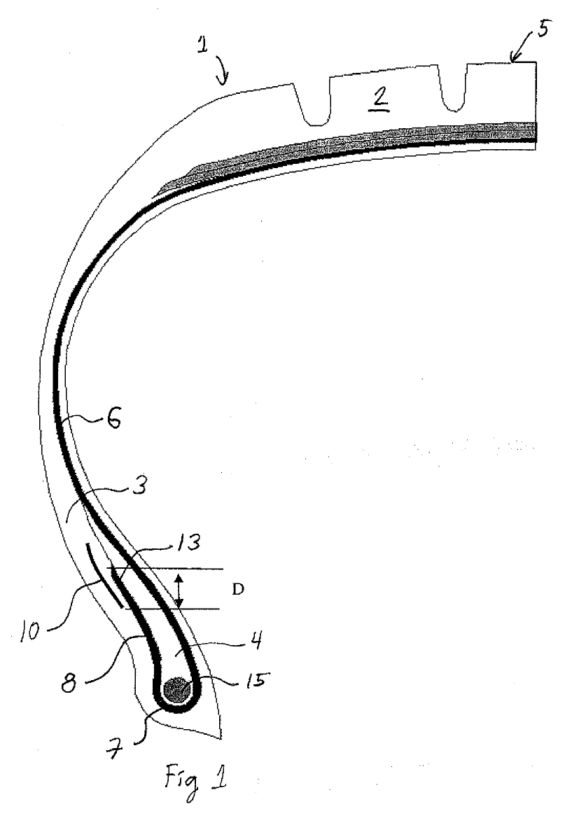

FIG. 1 shows a transverse section through half of a tire with a sidewall and a portion of the crown, with a first example of the positioning of a bielastic reinforcing element;

FIG. 2 shows the lower region of a tire according to the invention, with a second example of the positioning of a bielastic reinforcing element;

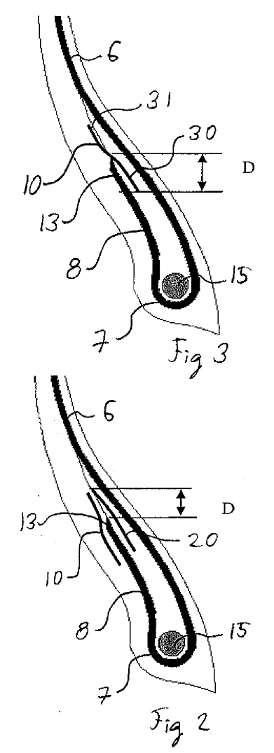

FIG. 3 is a cross section similar to that of FIG. 2, with a third example of the positioning of a bielastic reinforcing element;

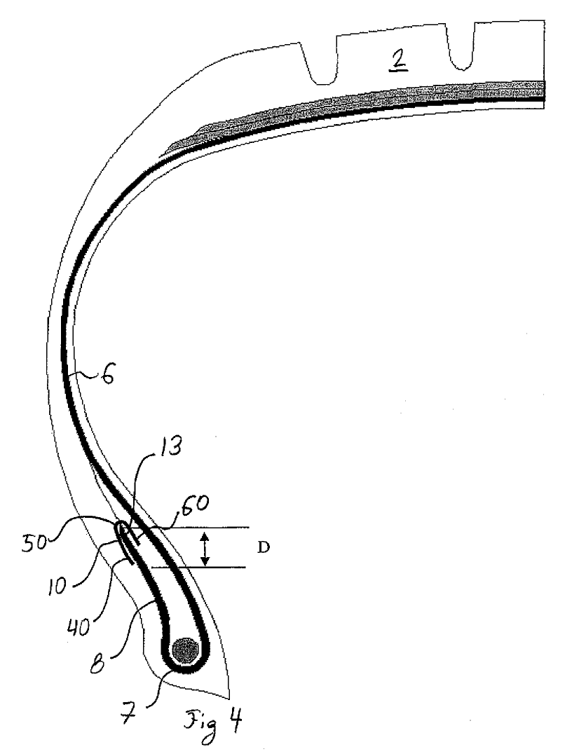

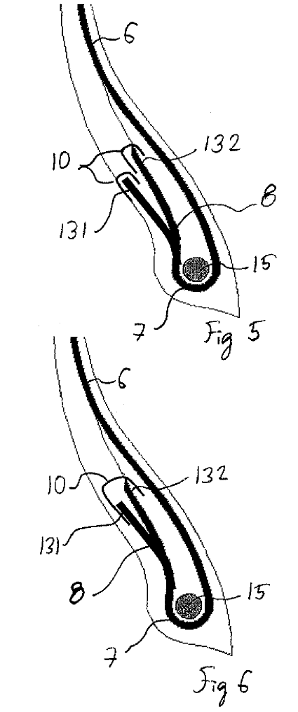

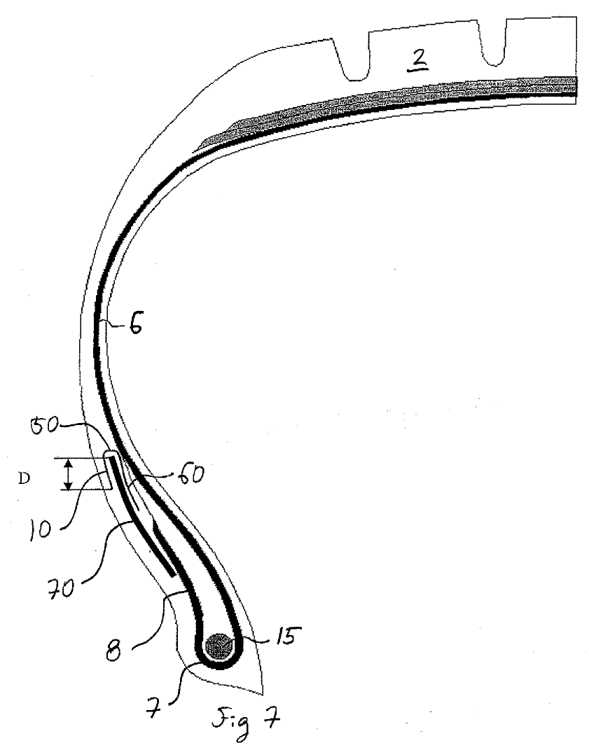

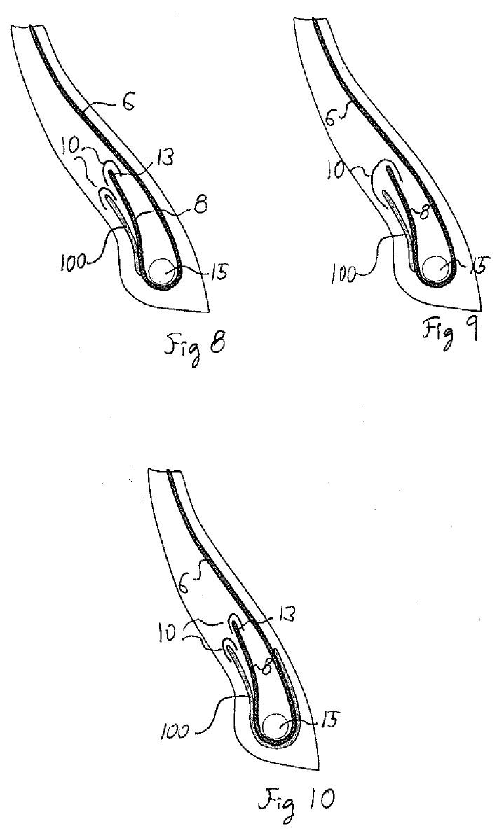

FIG. 4 is a cross section similar to that of FIG. 1, with a fourth example of the positioning of a bielastic reinforcing element;

FIG. 5 is a cross section similar to that of FIG. 2, with a fifth example of the positioning of a bielastic reinforcing element;

FIG. 6 is a cross section similar to that of FIG. 2, with a sixth example of the positioning of a bielastic reinforcing element;

FIG. 7 is a cross section similar to that of FIG. 1, with a seventh example of the positioning of a bielastic reinforcing element;

FIGS. 8, 9 and 10 show variants with different forms of strips in the lower region, near the anchoring region; and

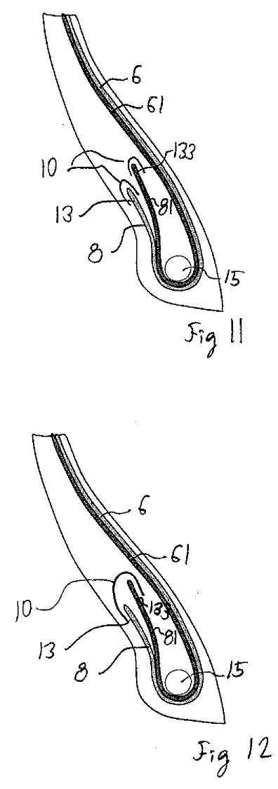

FIGS. 11 and 12 show variants with two carcass-type reinforcing structures.

The term “axial” is used to mean a direction parallel to the axis of rotation of the tire. This direction may be “axially inward” when directed into the tire and “axially outward” when directed toward the outside of the tire.

The term “crown reinforcing structure” is used in the text. Usually, this element is often denoted by the term “crown reinforcement”.

FIG. 1 shows in diagrammatic form a radial half cross section through a tire 1 with a carcass reinforcement. This tire 1 comprises a crown 2, sidewalls 3, beads 4, and a carcass-type reinforcing structure 6 extending preferably from one bead to the other. On top of the crown 2 is a tread 5. The reinforcing structures 6 are anchored in the bead in the conventional way, by wrapping them around a bead core 15. This form of anchoring comprises a turning up of said carcass-type reinforcing structure 6 around a bead core 15 in such a way as to form, along a radially inner portion of the bead core, a turning-up portion 7 of the reinforcing structure from a point axially inside the bead core to a point axially outside the bead core, and then extending radially out from the base of said bead core in such a way as to form a turned-up section 8 ending in a free end 13.

At least one bielastic reinforcing element 10 is arranged near the turned-up section 8, preferably near the region of the end 13. In FIG. 1, element 10 is positioned axially on the outside of the turned-up section 8, with a radial alignment such that the end 13 of this portion 8 is located substantially between the two ends of the element 10. In this example of FIG. 1, at least one of the ends of the element 10 is at a radial distance D of at least 5 mm from the end 13.

In FIG. 2, the element 10 is positioned in a similar way to the example of FIG. 1. A second element 20 is arranged axially inwardly relative to the turned-up section 8, with a radial alignment such that the end 13 is located substantially between the two ends of the element 20. In this example of FIG. 2, at least one of the ends of the element 20 is at a radial distance D of at least 5 mm from the end 13. The radially outer end of the element 20 can be located axially outwardly relative to the end 13.

In the example shown in FIG. 3, the element 10 comprises a first portion 30 arranged axially inwardly relative to the turned-up section 8. The element 10 also comprises a second portion 31 which is continued radially outwardly past the end 13 of the turned-up section 8. This portion 31 is continued axially outwardly relative to said end 13.

In the examples of FIGS. 4 to 6, the bielastic reinforcing element forms an inverted U-shaped hook which at least partly encloses at least one end 13, 131, 132 of a turned-up section 8. In FIG. 4, therefore, said bielastic reinforcing element comprises a first, substantially radial portion 40 arranged axially outwardly relative to the end 13, a second, substantially radial portion 60 arranged axially inwardly relative to the end 13, and a third portion 50 that is curvilinear or in the form of an arc of a circle, connecting together the first two portions 40 and 60 by passing radially outwardly relative to the end 13.

In FIGS. 5 and 6, the turned-up section 8 of the carcass-type reinforcing structure is divided into at least two series of thread ends 131, 132 that are spaced out axially and are arranged so that they alternate circumferentially: in the example shown in FIG. 5, said hook individually encloses each series of ends 131 and 132; in the example shown in FIG. 6, said hook simultaneously encloses the two series of ends 131 and 132.

In a similar way to the example shown in FIG. 4, FIG. 7 presents an example in which said bielastic reinforcing element also forms an inverted U-shaped hook. However, in this example the hook at least partly encloses at least one end of a stiffener 70. This kind of stiffener comprises for example a series of metal wires or textile threads, and is designed to give relatively great rigidity to the lower region of the tire.

In the examples of embodiments shown in FIGS. 11 and 12, the tire comprises two reinforcing structures 6 and 61, each comprising a turned-up portion 8 and 81, each of which has an end 13 and 133, and said bielastic reinforcing element 10 engages on at least one of these two ends. In the example shown in FIG. 11, a bielastic reinforcing element is provided for each end of the reinforcing structure. In this example the reinforcing elements are arranged in an inverted U shape fitting over the end. According to the invention, multiple other shapes can be used for the arrangement of the reinforcing elements.

In the example shown in FIG. 12, a single bielastic reinforcing element is provided to engage simultaneously on both ends of the reinforcing structure. In this example the reinforcing element is arranged in an inverted U shape fitting over the ends. According to the invention, multiple other shapes can be used for the arrangement of the reinforcing element.

In the examples of embodiments shown in FIGS. 8, 9 and 10, the tire comprises a known type of circumferential strip 100 which has threadlike reinforcing elements and is juxtaposed to at least one portion of an end 13, said bielastic reinforcing element 10 cooperating with said strip. In the example of FIG. 8, a bielastic reinforcing element is provided for each end, that is to say the end of the strip and that of the reinforcing structure. In this example, the reinforcing elements are arranged in an inverted U shape fitting over each end. According to the invention, multiple other shapes can be used for the arrangement of the reinforcing elements.

In the example shown in FIG. 9, a single bielastic reinforcing element is provided to cooperate simultaneously with both ends, that is the end of the strip and that of the reinforcing structure. In this example, the reinforcing element is arranged in an inverted U shape fitting over the ends. According to the invention, multiple other shapes can be used for the arrangement of the reinforcing element. FIG. 10 presents a variant with a strip that is continued in a known manner underneath the bead core towards the axially inward side of the lower region. The end of the strip and the end of the reinforcing structure can be protected in a similar way to the examples seen in FIGS. 8 and 9.

The reinforcing element 10 is advantageously made of a highly deformable elastic knitted fabric of low apparent density. This allows elasticity because of the sliding of the threads and the deformation of the stitches. It allows some degree of mechanical decoupling between the different architectural components between which it is laid. Furthermore, the advantage of an elastic knitted fabric is clearly that it has sufficient structural flexibility to follow the deformations of the tire. Various kinds of material can therefore be selected to produce this elastic knitted fabric: its thickness, its proportion of voids and its density are directly related to this choice and to the structure of the knitted fabric (thread diameter, number of stitches per dm and tightness).

The bielastic fabric has at least one and preferably all of the following properties:

an elastic elongation ratio of at least 8%, and

a stitch size of less than or equal to 150 stitches per decimeter, and preferably 200 stitches per decimeter.

For example, tests performed on a knitted fabric having 240 stitches per decimeter on one side, and 235 stitches per decimeter on the other, gave very advantageous results, notably in terms of crack resistance.

Ordinarily, the bielastic knitted fabric according to the invention is made of synthetic fibers, natural fibers or a blend of these fibers. For synthetic fibers, the bielastic knitted fabric according to the invention may comprise at least one type of fiber selected from polyamide 6, polyamide 6,6 (nylon), polyesters, etc.

Thus, advantageously, said fabric comprises at least one material selected from polyamides, polyesters, rayon, cotton, wool, aramid, silk and flax.

According to an advantageous variant, a certain proportion of elastic threads such as polyurethane, latex, or natural or synthetic rubber can be useful to provide the elastic return, which helps in applying the fabric. Thus, for the bielastic knitted fabric according to the invention, the knitted fabric sold by Milliken under reference 2700 composed of 82% of polyamide 6 fiber and 18% of 44 dTex polyurethane may be mentioned.

The bielastic fabric or knitted fabric according to the invention has a thickness that may be from 0.2 mm to 2 mm, and preferably from 0.4 to 1.2 mm. Its mass per unit area is generally from 70 to 700 g/m², and preferably from 140 to 410 g/m².

According to a variant, the bielastic knitted fabric is composed of at least one polymer selected from heatsetting polymers and thermoplastic polymers.

The elastic knitted fabric should preferably have a density of at least 0.02 g/cm³, measured in the conventional way, which density may be up to 0.50 g/cm³.

Another feature of the elastic knitted fabric useable in the context of the invention is its void volume. In general terms, according to the invention, the void volume will advantageously be at least 40% so that the knitted fabric is sufficiently compressible. This void volume can be calculated by comparing the density of the knitted fabric with that of the compact material forming its matrix, measured by any conventional means.

Non-elastomeric materials that can be used for the matrix of these knitted fabrics include the following:

natural textile fibers, such as cotton, wool, flax, hemp, silk, etc.;

artificial textile fibers such as rayon;

synthetic textile fibers made of for example polyesters, polyamides, aramids, polyvinyl chloride, polyolefins, etc.;

and mineral fibers made of for example glass, silica, or mineral wool.

As elastomeric materials one may cite natural rubber, polybutadiene, SBR, polyurethane, etc.

1. A tire comprising at least one carcass-type reinforcing structure extending circumferentially from a bead to a sidewall and anchored on each side of the tire in said bead, the base of which latter is designed to be mounted on a wheel rim seat, said anchoring comprising a turning up of said carcass-type reinforcing structure around a bead core in such a way as to form, along a radially inner portion of the bead core, a turning-up portion of the reinforcing structure from a point axially inside the bead core to a point axially outside the bead core, and then extending radially out from the base of said bead core in such a way as to form a turned-up section ending in a free end, each bead being continued radially outwardly by a sidewall, the sidewalls meeting, in the radially outward direction, a tread, said tire also comprising at least one circumferential bielastic reinforcing element made of a bielastic fabric, in which the fabric employed is a bielastic knitted fabric, that is a stitched fabric, the loops forming the stitches of which are capable of moving relative to each other in the knitting direction and in the direction perpendicular to the knitting, said at least one bielastic reinforcing element being arranged so as to extend along the end zone of the turned-up section of the carcass-type reinforcing structure.

2. The tire of claim 1, wherein at least one bielastic reinforcement is arranged axially outwardly relative to the turned-up section of the carcass-type reinforcing structure.

3. The tire of claim 1, wherein at least one bielastic reinforcement is arranged axially inwardly relative to the turned-up section of the carcass-type reinforcing structure.

4. The tire of claim 1, wherein the bielastic reinforcement comprises on the one hand a portion arranged axially inwardly relative to the turned-up section of the carcass-type reinforcing structure, and on the other hand a portion that is continued radially outwardly past the end of the turned-up section of the carcass-type reinforcing structure.

5. The tire of claim 4, wherein said portion that is continued radially outwardly past the end of the turned-up section of the carcass-type reinforcing structure is continued axially outwardly relative to the turned-up section of the carcass-type reinforcing structure.

6. The tire of claim 1, wherein said bielastic reinforcing element comprises a first, substantially radial portion arranged axially outwardly relative to the turned-up section of the carcass-type reinforcing structure, a second, substantially radial portion arranged axially inwardly relative to the turned-up section of the carcass-type reinforcing structure, and a third, curvilinear portion connecting together the first two portions by passing radially outwardly relative to the end of the turned-up section of the carcass-type reinforcing structure, these various portions forming an inverted U-shaped hook enclosing at least one end of a turned-up section.

7. The tire of claim 6, wherein the turned-up section of the carcass-type reinforcing structure is divided into at least two series of thread ends that are spaced out axially and are arranged such that they alternate circumferentially, and said inverted U-shaped hook individually encloses each series of ends.

8. The tire of claim 6, wherein the turned-up section of the carcass-type reinforcing structure is divided into at least two series of thread ends that are spaced out axially and are arranged such that they alternate circumferentially, and said hook conjointly encloses each series of ends.

9. The tire of claim 1, comprising two reinforcing structures, each comprising a turned-up portion, each being provided with an end, and said bielastic reinforcing element being engaged on at least one of these two ends.

10. The tire of claim 1, comprising a circumferential strip provided with threadlike reinforcing elements and juxtaposed on at least one portion of an end, said bielastic reinforcing element being engaged on said strip.

11. The tire of claim 1, wherein the bielastic fabric has at least one of the following properties:
an elastic elongation ratio of at least 8%, and
a stitch size less than or equal to 150 stitches per decimeter, and preferably 200 stitches per decimeter.

12. The tire of claim 1, wherein said fabric comprises at least one material selected from polyamides, polyesters, rayon, cotton, wool, aramid, silk and flax.

13. The tire of claim 1, wherein the fabric comprises a certain proportion of elastic threads.

14. The tire of claim 1, wherein the fabric or knitted fabric has a thickness between 0.2 mm and 2 mm, and preferably between 0.4 and 1.2 mm.

15. The tire of claim 1, wherein the fabric or knitted fabric has a mass per unit area of generally between 70 and 700 g/m², and preferably between 140 and 410 g/m².

16. The tire of claim 1, wherein the bielastic knitted fabric is composed of at least one polymer selected from heatsetting polymers and thermoplastic polymers.
